(19) United States
(12) Patent Application Publication
(10) Pub. No.: US 2020/0090063 A1
(43) Pub. Date: Mar. 19, 2020

(54) A METHOD AND SYSTEM FOR GENERATING A DECISION-MAKING ALGORITHM FOR AN ENTITY TO ACHIEVE AN OBJECTIVE

(71) Applicant: FACTOR FINANCIAL ANALYTICS PTY LTD, Sydney (AU)

(72) Inventors: Paul REYNOLDS, Sydney (AU); Martin KEMKA, Sydney (AU)

(73) Assignee: FACTOR FINANCIAL ANALYTICS PTY LTD, Sydney (AU)

(21) Appl. No.: 16/470,538

(22) PCT Filed: Dec. 18, 2017
(86) PCT No.: PCT/IB2017/058070

§ 371 Date: Jun. 17, 2019

(30) Foreign Application Priority Data
Dec. 16, 2016 (AU) 2016905215

(51) Int. Cl. G06N 5/04; G06F 17/18

(52) U.S. Cl. CPC G06N 5/045; G06F 17/18

(57) ABSTRACT

An analytics processing system for generating a decision-making algorithm based on a prescribed set of pre-defined data points describing one or more characteristics of an entity to achieve an objective. The objective is modelled by an underlying base algorithm. The system includes a user interface to receive initial data concerning the objective from a client. It also includes a decision engine comprising a pipeline of modules including a validation module, a retrospect module, a refinement module and a comparison module. These modules perform the following functions in iterative phases:
(i) derive a base algorithm to best match a candidate-entity to a known model having regard to the initial data;
(ii) input select data related to the candidate-entity from a source of data;
(iii) produce an output score being a function of the base algorithm;
(iv) derive a predicted probability from the output score;
(iv) compare the predicted probability with an actual outcome based on actual data derived from the source data at a subsequent period of time relative to the select data;
(v) generate a variant of the base algorithm based upon the results of the comparison;
(vi) create a new decision-making algorithm based on the variant; and
(vii) periodically perform the aforementioned steps using the new decision-making algorithm as the derivative of the base algorithm after the prescribed period of time.

The select data is prescribed to characterise a plurality of pre-defined data points associated with the base algorithm selected to provide a qualitative measure of performance to achieve the objective; The output score is derived from applying the select data for each data point and running the base algorithm thereon. The predicted probability is a weighted variable of the data points that is used to predict the likelihood of the objective being achieved.

### FIELD OF THE INVENTION

This invention relates to a method and system for generating a decision-making algorithm for an entity to achieve an objective. It has particular, but not exclusive, utility in the financial service area for assessing the likely achievement of an objective such as the credit-worthiness of an entity based upon financial data derived from or in relation to the entity on an evolving basis for making financial decisions based upon that data.

The invention, however, is not limited in application to the financial services area, but also may find utility in data analytics generally and specifically in areas where there is a requirement for real time customer level decisions in relationship to an entity achieving an objective, and where current entity data can be applied to support decision making analytics.

Throughout the specification, unless the context requires otherwise, the word “comprise” or variations such as “comprises” or “comprising”, will be understood to imply the inclusion of a stated integer or group of integers but not the exclusion of any other integer or group of integers.

Furthermore, the following terms are ascribed the indicated meanings:
“algorithm” is a process or set of rules to be followed in calculations or other problem-solving operations by a computer. In the context of this specification, ‘algorithm’ is at a lower or finer level of granularity than is a model;
“model” is an abstract mathematical or graphical representation of a financial, economic, manufacturing, social and other applicable situation simulated using one or more algorithms run on a computer.

### BACKGROUND ART

The following discussion of the background art is intended to facilitate an understanding of the present invention only. It should be appreciated that the discussion is not an acknowledgement or admission that any of the material referred to was part of the common general knowledge as at the priority date of the application.

It should also be appreciated that the discussion is not an acknowledgement or admission that the invention is limited to application in the financial services area, but only be illustrative of the state of that industry and relevant to overcoming a shortfall or in that area, or providing an improvement to existing types of decision making systems.

It is usual for organisations involved with providing financial services, particularly those associated with providing finance or assessing risk, to undertake some form of financial analysis to assess the credit-worthiness of an entity seeking to obtain funding or repaying a debt.

In more sophisticated environments this financial analysis is performed using financial analytics that are computer-based using financial analysis software programs. Some of the more popular software programs include: Oracle™ Financial Analytics, SAP™ ERP Financial Analytics, SAS™ Business Analytics, IBM™ Cognos™ Finance and NetSuite™. These financial analytical tools generally provide for some type of data mining, text mining and predictive modelling to achieve customised objects of an organisation. For example:
Oracle's financial analytics enable an organisation to gain insight into their general ledger, performance against budget and the way staffing costs and employee or supplier performance affects revenue and customer satisfaction;
SAP's financial analytics help organisations define financial goals, develop business plans and monitor costs and revenue during execution;
SAS's business analytics uses a mathematical model that predicts future outcomes, as well is descriptive modelling of historical events and the relationships that created them;
IBM's financial analytics provides data analysis capabilities for sales, supply chain procurement and workforce management functions; and
Net Suite's financial analytics provides financial dashboards, reporting and analytic functions that allow personal key performance indicators to be monitored in real time.

In terms of credit decision analytics, however, despite the sophistication of these programs in collecting financial data, there is a tendency for organisations to rely upon legacy decision scorecards, which are based on static-data that is captured at the time that an application for credit is made—predominantly through application form data provided by an applicant and credit-specific databases including credit bureaus. The decision scorecards are fixed and applied against all customers within a segment—predicting how a customer would perform/behave in comparison to a population of customers within that segment. For example, a consumer credit card scorecard will be applied to all customers applying for credit, with some input variable weighting adjustment for areas such as industry of employment. The applicant is assessed on how they would perform based on the scorecard built on the population's (or sub-segment i.e. employment industry's) expected performance.

These legacy decision systems, being built on using customer-level static data (snapshot at a point in time) and applying that data to decision scorecards built on a population's expected performance, create inherent problems with assessing the credit-worthiness or financial viability of an entity that nowadays is operating in a very dynamic business environment, where the performance of an entity can be quite atypical to the population in which it operates.

The availability of financial and other data in relation to an entity has significantly changed in more recent times. IBM has publicly stated that 90% of the world's data has been created within the past 2 years, with the majority of the data being captured by enterprises connected with entity consumer activity.

This data is typically dynamic by nature, meaning that specific data points are captured and tracked over time (referred to as time sensitive dynamic data). This data creation and capture has been a result of Internet related services, including but not limited to mobile devices, applications (apps), 3G/4G mobile data and broadband networks, cloud-based data storage and server environments—the latter resulting in the shift of data being stored at a personal level (e.g. personal computers) to a centralised level, allowing easier access by third parties who want to use that data to provide better customer service and better understand customer behaviour. Collectively this shift and increased level of data captured is commonly referred to as “big data”.

Individual entity behaviour and risk profiles of entities can change based on their circumstances. Therefore dynamic data on an individual entity can better reflect an entity's behaviour and risk profile.

The availability of a large amount of time sensitive dynamic data at the customer level presents a challenge on how to extract the full value of the data. However, the availability of entity level time sensitive dynamic data that records an entity's actual performance creates the opportunity to learn entity specific behaviour and more accurately predict entity-level performance.

Data analytics is now starting to make use of dynamic data and systems are appearing that make use of predictive models and measuring the performance and accuracy of these to find a best match against actual performance of an entity having regard to prescribed data points at different stages in time, thus being representative of the effect of dynamic data.

Models are created by using a number of variable data points and weighted coefficients to predict the likelihood of an outcome related to the individual entity.

Typically, models are created for the same species (e.g. industry, profession, market segment) and sub-species from a genus data source of available data. With each individual entity having different characteristics, the best-fit model will be a variant based on a combination and permutation of data points to more accurately predict an outcome.

When time-series data is available, the best-fit model can be back-tested at a historic point in time and analyse the predicted outcome against the actual outcome. This would be required to be performed for a potentially large number of combinations and permutations which increase as data available in the genus increases in parallel with the collection of big data.

Thus identifying and selecting the best-fit model at a point in time becomes a complicated process.

A further problem with these systems, however, is that the algorithms they deploy to achieve this type of functionality, even though they may be genetic in nature, are limited by the constraints of the data source to which the data points are applied and may taint the accuracy and performance of the system and the model evolved.

### DISCLOSURE OF THE INVENTION

The present invention makes use of the change in data historically being of a static nature to, in more recent times, being of a dynamic nature, and thus is concerned with the use dynamic data.

Further, the invention takes advantage of the realisation that in addition to models created for the same species and sub-species, an individual entity's behaviour and risk profile may be more accurately predicted by a model of another species in the same genus of data. It does this by expanding the best-fit model identification to include other species models.

In addition to the models created on the same genus of data, the invention further realises that an individual entity's behaviour and risk profile may be more accurately predicted by other geni of data sources and associated models. This may occur where another genus of data has more accurate and/or representative data on the individual entity.

Thus, the invention expands the scope of data which is accessed from one source or genus to other sources or geni, and forensically tests models in this larger domain to find a better matching model that predicts the performance of an entity to achieve a particular objective having regard to actual performance. In this manner, the invention helps refine an evolving model that is of higher quality than existing models for predictive purposes of the performance of that entity.

Despite the invention realising the value of data in other species and geni, and in particular models developed for these other sources, access to other genus source-data in particular may have privacy and commercial restrictions.

Furthermore, individual entities may use a variety of different technology platforms in their business operations which capture dynamic data specific to that entity. This creates multiple geni of data sources, where each genus captures data and structures it in a different scheme from other geni. This will result in each data genus requiring their own customised models using the data captured in their scheme.

This presents a particular technical problem to present data analytic systems, which are limited to accessing only genus species models and data that are homogeneous with the primary data source accessed by the system.

Thus it is not only an object of the present invention to efficiently make use of big data and generate a decision-making algorithm to assist in assessing the historical and dynamic performance of an entity to achieve a particular objective, and making a decision on the likelihood of the entity being able to achieve that objective based on predictive modelling of that performance, but to also expand the utility of the present invention to enabling data sources to be accessed that are more heterogeneous in nature.

In accordance with one aspect of the present invention, there is provided a computer-implemented method for generating a decision-making algorithm based on a prescribed set of pre-defined data points describing one or more characteristics of an entity to achieve an objective within a domain of data, modelled by an underlying base algorithm, the method including:
(i) deriving a base algorithm to best match a candidate-entity to a known model having regard to initial data concerning the objective provided by a client;
(ii) inputting select data related to the candidate-entity from a source of data, the select data being prescribed to characterise a plurality of pre-defined data points associated with the base algorithm selected to provide a qualitative measure of performance to achieve the objective;
(iii) producing an output score being a function of the base algorithm, the output score being derived from applying the select data for each data point and running the base algorithm thereon;
(iv) deriving a predicted probability from the output score, the predicted probability being a weighted variable of the data points that is used to predict the likelihood of the objective being achieved;
(v) comparing the predicted probability with an actual outcome based on actual data derived from the source data at a subsequent period of time relative to the select data;
(vi) generating a variant of the base algorithm based upon the results of the comparison;
(vii) creating a new decision-making algorithm based on the variant; and
(viii) testing the new decision-making algorithm against other data variables increasing the domain of data applicable to the candidate-entity; and
(ix) producing a better-fit model to create a revised new decision-making algorithm if justified by the other data variables.

Preferably, the other data variables are provided from the same data source as the initial domain.

Preferably, the method including iteratively recalculating the weighting of each of the matched “best-model” variables and re-running a logistic regression function to create a revised model.

Preferably, the method including applying a combination of external variables from the initial domain in combination with the revised model to recalculate a better fitting model to constitute the revised new decision-making algorithm.

Preferably, the other data variables are provided, or are additionally provided, from a different data source to that of the initial domain.

Preferably, the method including:
(i) retrospectively testing the best-fit model constituting the revised new decision-making algorithm against a representative sample of candidate time sensitive data within the same data source and using the same data points and time period to create sample data;
(ii) calibrating the sample data actual performance and predicted performance using the revised new decision-making algorithm; and
(iii) assessing the revised new decision-making algorithm to both accurately predict the outcome and discriminate positive and negative results of the outcome of the revised new decision-making algorithm; and
storing the results as a calibration factor.

Preferably, the method including retrospectively testing the revised new decision-making algorithm against candidate-entity time sensitive data to create candidate-entity test results.

Preferably, the method including:
(i) applying the candidate-entity test results against its calibration factor to generate a calibrated candidate-entity test result,
(ii) comparing the best-fit model constituting the revised new decision-making algorithm as generated from data within the previous data source with the calibrated candidate-entity test results; and
(iii) selecting the model with the highest performing result as the “best-fit model” for the candidate-entity to constitute the ultimate decision-making algorithm for that candidate-entity.

Preferably, the method including periodically performing the aforementioned steps using the ultimate decision-making algorithm as the derivative of the base algorithm after the prescribed period of time.

Preferably, during an initial phase of performing the method, where historical time sensitive dynamic data exists in the data source, the method includes at step (ii), inputting retrospective select data related to the candidate-entity from the source of data at a known point of time preceding the time when the actual data was generated; and using the retrospective select data as the select data for the purposes of producing the output score.

Alternatively, where historical time sensitive dynamic data does not exist in the data source, the method may complete an initial phase up to and including step (iv), and after a prescribed period of time, commence a subsequent phase including:
(a) inputting a new set of select data related to the candidate-entity from the source of data for each of the data points;
(b) producing a new output score derived from running the base algorithm on the select data for each data point;
(c) deriving a new predicted outcome probability from the new output score;
(d) comparing the previous predicted probability with an actual outcome based on actual data derived from the source data at a subsequent period of time relative to the select data of the preceding phase;
(e) generating a variant of the base algorithm based upon the results of the comparison;
(f) creating a new decision-making algorithm based on the variant; and
(g) periodically performing the subsequent phase using the new decision-making algorithm as the derivative of the base algorithm after the prescribed period of time.

Preferably, the method includes performing a validation step at the commencement of any phase where select data is input from the source data, the validation step including:
verifying and validating select data for the candidate-entity to establish a validated candidate-entity dataset including time data prescribing the period of time to service the objective for decision-making purposes.

Preferably, the subsequent phase includes performing a retrospect step after the validation step, including:
calculating an output score using the base algorithm as a function of the validated candidate-entity dataset combined with the coefficients derived from the matched known model, from which a predicted probability of achieving the objective for the candidate-entity is derived;
matching the predicted probability to the actual performance of the candidate-entity of the objective outcome after the prescribed period of time for servicing;
comparing the level of fluctuation between the predicted probability of the objective and the actual performance using a function that gauges the margin of error depending on the number of candidate-entity observations; and
storing the results of this comparison as well as any response timing issues and quality issues to enable correlations to be presented in an output report.

Preferably, the subsequent phase includes performing a refinement step after the retrospect step, including:
refitting the previously selected base algorithm used in processing of the candidate-entity data with a new decision-making algorithm derived from using modified models and algorithms therefor based on feedback of actual performance data of the candidate-entity derived from the big data;
comparing the predicted performance to actual performance of the candidate-entity; and
logging refined models/algorithms for the candidate-entity.

Preferably, the subsequent phase includes performing a comparison step after the refinement step, including:
comparing the score results of the refined models and algorithms with the score results of established models and algorithms for the particular model type associated with the category of the candidate-entity objective;
applying a function across the score results to determine a ranking system based on the perceived additional value of each of the models and algorithms;
identifying the highest performing score for the particular model type; and
outputting the results providing a measure of the differences in the predictive power of each model type.

In accordance with another aspect of the present invention, there is provided an analytics processing system for generating a decision-making algorithm based on a prescribed set of pre-defined data points describing one or more characteristics of an entity to achieve an objective within a domain of data initially, modelled by an underlying base algorithm, the system comprising:
a user interface to receive initial data concerning the objective from a client; and
a decision engine including a pipeline of modules programmed to:
   derive a base algorithm to best match a candidate-entity to a known model having regard to the initial data;
   (ii) input select data related to the candidate-entity from a source of data;
   (iii) produce an output score being a function of the base algorithm;
   (iv) derive a predicted probability from the output score;
   (v) compare the predicted probability with an actual outcome based on actual data derived from the source data at a subsequent period of time relative to the select data;
   (vi) generate a variant of the base algorithm based upon the results of the comparison;
   (vii) create a new decision-making algorithm based on the variant;
   (viii) test the new decision-making algorithm against other data variables increasing the domain of data applicable to the candidate-entity; and
   (ix) produce a better-fit model to create a revised new decision-making algorithm if justified by the other data variables;
wherein:
   (a) the select data is prescribed to characterise a plurality of pre-defined data points associated with the base algorithm selected to provide a qualitative measure of performance to achieve the objective;
   (b) the output score is derived from applying the select data for each data point and running the base algorithm thereon; and
   (c) the predicted probability is a weighted variable of the data points that is used to predict the likelihood of the objective being achieved.

Preferably, the other data variables are provided from the same data source as the initial domain.

Preferably, the pipeline of modules is programmed to iteratively recalculate the weighting of each of the matched “best-model” variables and re-run a logistic regression function to create a revised model.

Preferably, the pipeline of modules is programmed to apply a combination of external variables from the initial domain in combination with the revised model to recalculate a better fitting model to constitute the revised new decision-making algorithm.

Preferably, the other data variables are provided, or are additionally provided, from a different data source to that of the initial domain.

Preferably, the pipeline of modules is programmed to:
(i) retrospectively test the best-fit model constituting the revised new decision-making algorithm against a representative sample of candidate time sensitive data within the same data source and use the same data points and time period to create sample data;
(ii) calibrate the sample data actual performance and predicted performance using the revised new decision-making algorithm; and
(iii) assess the revised new decision-making algorithm to both accurately predict the outcome and discriminate positive and negative results of the outcome of the revised new decision-making algorithm; and
store the results as a calibration factor.

Preferably, the pipeline of modules is programmed to retrospectively test the revised new decision-making algorithm against candidate-entity time sensitive data to create candidate-entity test results.

Preferably, the pipeline of modules is programmed to:
(i) apply the candidate-entity test results against its calibration factor to generate a calibrated candidate-entity test result,
(ii) compare the best-fit model constituting the revised new decision-making algorithm as generated from data within the previous data source with the calibrated candidate-entity test results; and
(iii) select the model with the highest performing result as the “best-fit model” for the candidate-entity to constitute the ultimate decision-making algorithm for that candidate-entity.

Preferably, the pipeline of modules is programmed to periodically perform the aforementioned steps using the ultimate decision-making algorithm as the derivative of the base algorithm after the prescribed period of time.

Preferably, the pipeline of modules is programmed to, during an initial phase where historical time sensitive dynamic data exists in the data source:
input retrospective select data related to the candidate-entity from the source of data at a known point of time preceding the time when the actual data was generated; and use the retrospective select data as the select data for the purposes of producing the output score.

Alternatively, the pipeline of modules may be programmed to complete an initial phase up to function (iv) of the present aspect of the invention, where historical time sensitive dynamic data does not exist in the data source, including functions to:
input a new set of select data related to the candidate-entity from the source of data for each of the data points;
produce a new output score derived from running the base algorithm on the select data for each data point;
derive a new predicted outcome probability from the new output score;
compare the previous predicted probability with an actual outcome based on actual data derived from the source data at a subsequent period of time relative to the select data of the preceding phase;
generate a variant of the base algorithm based upon the results of the comparison;
create a new decision-making algorithm based on the variant; and
periodically perform the subsequent phase using the new decision-making algorithm as the derivative of the base algorithm after the prescribed period of time.

Preferably, the pipeline of modules includes a validation module for invoking by the decision engine at the commencement of any phase where select data is input from the source data, the validation module including processes to verify and validate select data for the candidate-entity to establish a validated candidate-entity dataset including time data prescribing the period of time to service the objective for decision-making purposes.

Preferably, the pipeline of modules includes a retrospect module for invoking by the decision engine during a subsequent phase, the retrospect module including processes to:
calculate an output score using the base algorithm as a function of the validated candidate-entity dataset combined with the coefficients derived from the matched known model, from which a predicted probability of achieving the objective for the candidate-entity is derived;
match the predicted probability to the actual performance of the candidate-entity of the objective outcome after the prescribed period of time for servicing;
compare the level of fluctuation between the predicted probability of the objective and the actual performance using a function that gauges the margin of error depending on the number of candidate-entity observations; and
store the results of this comparison as well as any response timing issues and quality issues to enable correlations to be presented in an output report.

Preferably, the pipeline of modules includes a refinement module for invoking by the decision engine during the subsequent phase after the retrospect module, the refinement module including functions to:
refit the previously selected base algorithm used in processing of the candidate-entity data with a new decision-making algorithm derived from using modified models and algorithms therefor based on feedback of actual performance data of the candidate-entity derived from the big data;
compare the predicted performance to actual performance of the candidate-entity; and
log refined models/algorithms for the candidate-entity.

Preferably, the pipeline of modules includes a comparison module for invoking by the decision engine during the subsequent phase after the refinement module, the comparison module including functions to:
compare the score results of the refined models and algorithms with the score results of established models and algorithms for the particular model type associated with the category of the candidate-entity objective;
apply a function across the score results to determine a ranking system based on the perceived additional value of each of the models and algorithms;
identify the highest performing score for the particular model type; and
output the results providing a measure of the differences in the predictive power of each model type.

### BRIEF DESCRIPTION OF THE DRAWINGS

The invention will be better understood in the light of the ensuing description of the best mode for carrying out the invention. The description is made with reference to the following drawings of a specific embodiment of the best mode, wherein:

FIG. 1 is a block diagram of an overview of the financial data processing system in a client-server configuration;

FIG. 2 is a block diagram showing the high-level architecture of the decision engine of the software application;

FIG. 3 is a block diagram showing the four modules that constitute the data pipeline of the decision engine;

FIG. 4 is a block diagram showing the process flow of a request sourced by a customer to access the decision engine;

FIG. 5 is a series of block diagrams showing the main functions performed by the various modules, wherein:

FIG. 5A shows the validation module,

FIG. 5B shows the retrospect module,

FIG. 5C shows the refinement module, and

FIG. 5D shows the comparison module;

FIG. 6 is series of block diagrams showing the flow of processes performed by the various modules, wherein:

FIG. 6A shows the validation module,

FIG. 6B shows the retrospect module,

FIG. 6C shows the refinement module, and

FIG. 6D shows the comparison module;

FIG. 7 is a series of more detailed flowcharts corresponding to FIG. 6, wherein:

FIG. 7A shows the validation module processes,

FIG. 7B shows the retrospect module processes,

FIG. 7C shows the refinement module processes, and

FIG. 7D shows the comparison module processes; and

FIG. 8 is a more detailed flowchart, showing the methodology of the best fit comparison performed by the comparison module process.

### BEST MODE(S) FOR CARRYING OUT THE INVENTION

The best mode for carrying out the invention involves the provision of a computer platform, typically in the form of a client-server structure, that can be operated over a network such as the Internet.

The specific embodiment of the invention described in accordance with the best mode, is directed towards an analytics processing system specifically designed to enable an organisation to assess an objective for an entity to achieve, such as the credit-worthiness or financial viability of an entity. This assessment is characterised by having regard to the historical and dynamic performance of the entity over a period of time. Thus, the analytics processing system takes into account historical and dynamic data in relation to a prescribed set of data points to enable a decision to be made on the likelihood of the entity being able to achieve the particular objective based on predictive modelling of the dynamic performance of the entity compared to actual performance. The predictive models are refined each time the algorithm based on such is run by the analytics processing system to improve the accuracy of the decision-making process.

In the present embodiment, the entity could be an individual person or any type of organisation that in itself has had financial dealings in respect of which pre-defined data points concerning the entity have been accumulated and stored as part of big data. As such, select data in respect of the data points is capable of being accessed from big data through external data stores and retrieved by the analytics processing system for processing.

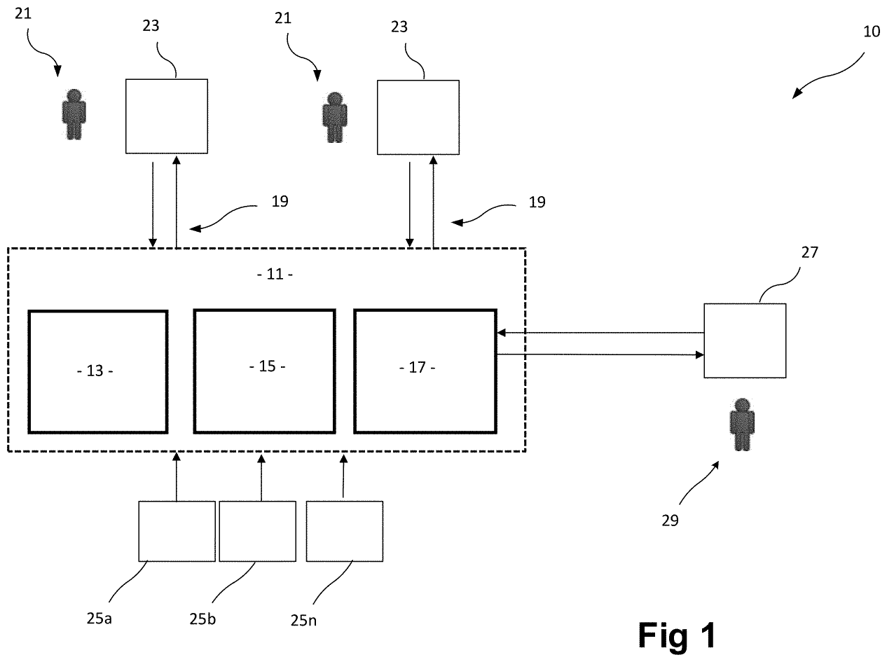

As shown in FIG. 1, the analytics processing system 10 includes application software 11 comprising a decision engine 13 implemented on a server or across a network of servers, an analytical model library and dictionaries 15 and an API module and supporting libraries 17.

The analytics processing system 10 further includes a user interface 19 allowing the decision engine 13 to communicate with a customer 21 typically being a bank or financial service provider requiring a risk assessment of a candidate-entity, via a client 23. The system 10 also includes suitable API connections to enable access and retrieval of select data in respect of the pre-defined data points from the big data stored in the external data stores 25 shown as a series of external source databases 25a, 25b . . . 25n.

Finally, the analytics processing system 10 includes provision for the API module and supporting libraries 17 to communicate with an external development toolkit 27 including a collection of diagnostic and analytic programs and libraries to enable a data scientist 29 to manage and administer the application software 11.

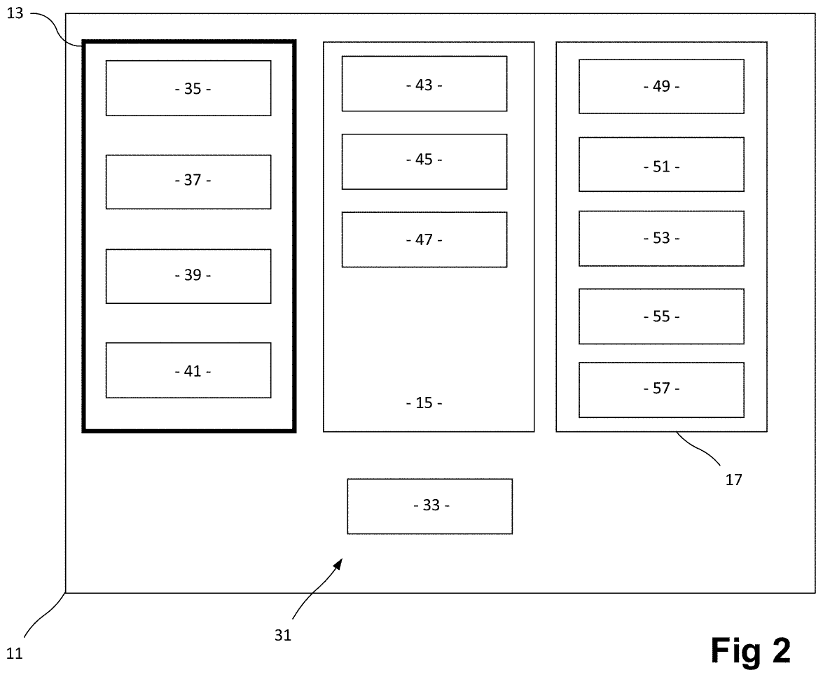

The high-level architecture of the application software 11 is shown in more detail in FIG. 2. In addition to the decision engine 13, the analytical model library and dictionaries 15 and API module and supporting libraries 17, the application software 11 includes a local development toolkit 31 as part of the original development system, which comprises development tools 33 accessible for use as appropriate by the decision engine 13 and data scientist 29

The decision engine 13 importantly includes four modules that essentially function as a pipeline for candidate-entity data to be progressed to create a decision-making algorithm. These modules comprise a validation module 35, a retrospect module 37, a refinement module 39 and a comparison module 41. These modules will be described in more detail later.

The analytical model library and dictionaries 15 comprise a strategies library 43, a models library 45 and an experiments sandbox 47. These libraries are accessed as prescribed by the modules 35 to 41 when the decision engine 13 is invoked in a manner to be described in more detail later.

The API module and supporting libraries 17 comprise an API library 49, a history library 51, a workflow library 53, a reporting library 55 and a sandbox 57. These libraries and areas are similarly invoked by the decision engine 13 as prescribed by the modules 35 to 41 in a manner to be described in more detail later.

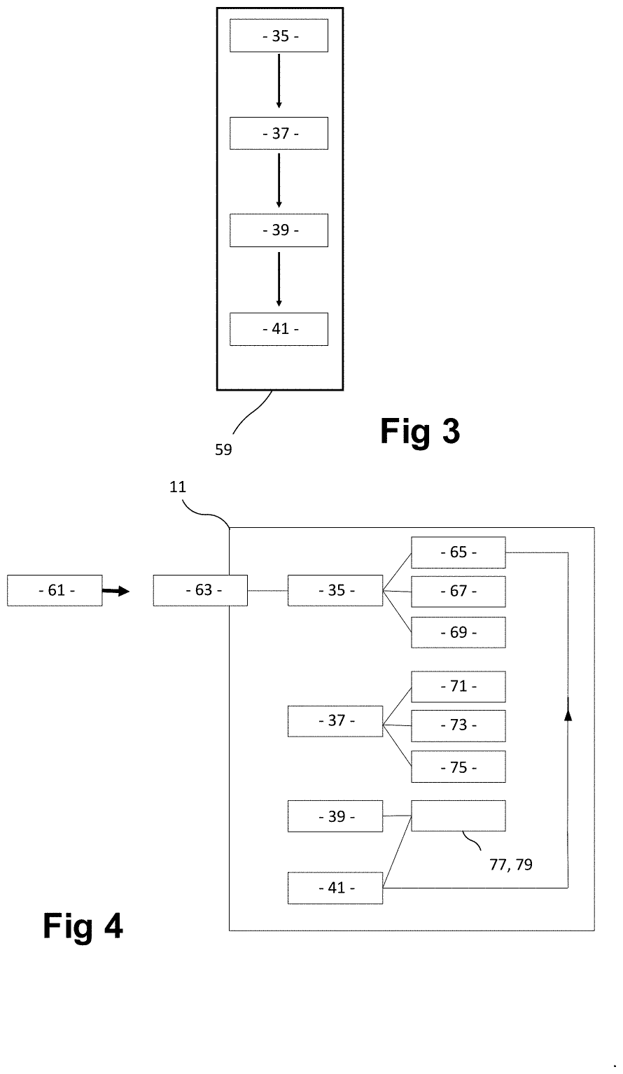

Having regard to FIGS. 3 and 4, the pipeline functioning of the modules of the decision engine 13 follows a general processing flow 59 whereby the validation module 35 essentially performs three functions:
(i) it firstly parses the authenticated and authorised request 61 input by a client 23 in respect of a candidate-entity as received from an API 63 invoked from the API module and supporting libraries 17, the request 61 including initial data indicative of an objective sought in relation to the candidate-entity, and matches the request 61 to a known model that is stored in an analytical model library 65 that best fits the objective in respect of which performance of the candidate-entity is to be measured—this known model then becomes a base algorithm for the candidate-entity;
(ii) then it accesses candidate select data in respect of the pre-defined data points associated with the base algorithm through the external source databases 25, which is iteratively verified against the expected bounds for each presented variable to become validated data—in subsequent phases of the pipeline, this becomes the starting point for invoking the validation module, as part of an iterative cycle of phases; and
(iii) finally it stores validated data in a response database within a response data structure 67 as well as time data prescribing the period of time to service the objective for decision-making purposes, to constitute a validated candidate-entity dataset, any errors or inconsistencies being recorded in a quality database within a quality data object 69 for future information.

The retrospect module 37 then is invoked to:
(i) calculate an output score using the base algorithm as a function of the validated candidate-entity dataset combined with the coefficients derived from the matched known model, from which a predicted probability of achieving the objective for the candidate-entity is derived—in subsequent phases of the pipeline, where historic output scores of the matched known model are available, either through stored results of previous processing of the candidate-entity data by the decision engine 13, or through the availability of time-sensitive dynamic data, the predicted probability of the objective is matched to the actual performance of the candidate-entity of the objective outcome after the prescribed period of time for servicing;
(ii) compare the level of fluctuation between the predicted probability of the objective and the actual performance using a function that gauges the margin of error depending on the number of candidate-entity observations; and
(iii) store the results of this comparison in a history database of a model history data element 71 as well as any response timing issues in a response issues object 73 and quality issues in a quality data element 75 to enable correlations to be presented in an output report.

Next the refinement module 39 is invoked to:
(i) refit the previously selected base algorithm used in processing of the candidate-entity data with a new decision-making algorithm derived from using modified models and algorithms therefor based on feedback of actual performance data of the candidate-entity derived from the big data;
(ii) compare the predicted performance to actual performance of the candidate-entity; and
(iii) log updated models for the candidate-entity.

Finally, the comparison module 41 is invoked to:
(i) compare the uplift and generate multipliers based on same; and
(ii) output the results to the reporting library.

The actual flow methodology of the data pipeline is more particularly shown in FIG. 4, whereby the decision engine 13 is invoked by the authorisation request 61 via the user interface 19. The authorisation request includes a candidate-entity dataset 62 input from the client 23 comprising a customer authorisation identification (ID), and initial data in the form of an analytical model ID and candidate identifiers, which will be described in more detail later. The authorisation request is then processed by the API 63 selected from the API library 49 for this purpose. The API 63 invokes the decision engine 13 to step through and process the various modules 35 to 41 in a sequential manner, accessing relevant dictionaries and libraries in the analytical model library and dictionaries 15, the API module and supporting libraries 17 and the development toolkit 31 to achieve the specified functionality.

Validation Module

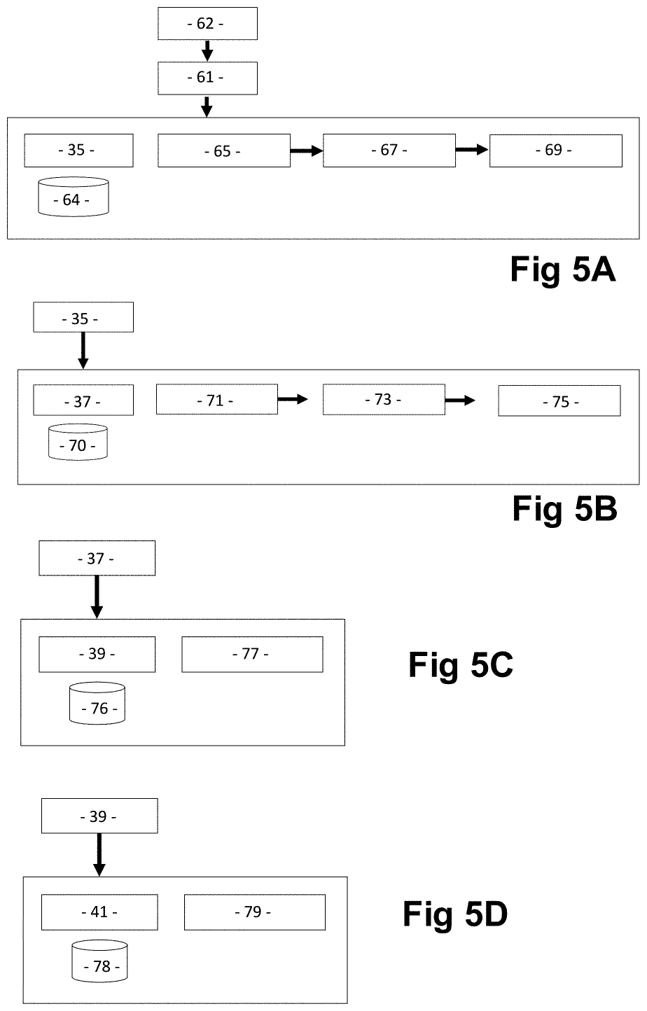

In the case of achieving the validation module 35 functionality, the validation is essentially embodied within a validation server/database 64. As shown in FIGS. 4 and 5, the decision engine 13 firstly invokes an analytical model library 65, which contains a set of functions that include:
(i) an identifying software script that performs data point identification and matching for the candidate-entity selected by the customer 21 using prescribed categories as to the entity type and purpose of the decision request as provided in an ‘Analytical Model’ ID by the customer;
(ii) an analytical model library database of previously established predictive models and algorithms based thereon, each designed to predict an outcome for a candidate-entity based on overall population behaviour reflected by the big data using select data in respect of the set of pre-defined data points for the candidate-entity sourced from the big data of the source databases 25a to 25n;
(iii) a matching software script that matches the list of models stored in the analytic model library database to an established “best model” to select the appropriate algorithm to run for the defined category of the selected candidate-entity; and
(iv) a validating software script that validates candidate select data in respect of each data point against established parameters for which the candidate select data can be valid and become validated data.

The decision engine 13 then invokes a response function stored in a response data structure 67 that comprises a database of validated candidate-entity datasets for the candidate-entity that includes:
validated data
identified error data
the matched model/algorithm and
time to service.

Then finally, the decision engine 13 invokes a quality function stored in the quality data object 69 that comprises a database that records errors or inconsistencies.

In operation terms, the validation module 35 essentially involves a process in which the candidate-entity identified by the customer's client 23 to the decision engine 13 has their dataset checked and validated against the expected plan schema and various other boundaries to ensure that it can be processed by the overall system in the expected correct manner.

The validation module 35 thus is a collection of software functions that interact with three database tables that contain information required to perform these tasks. These database tables cover: (i) data quality, (ii) data integrity and (iii) monitoring time to service.

As previously described, the first step involves a function that parses the authenticated and authorised request from the API 63 and matches it to a known model implemented by an algorithm that is stored in the analytical model library 65, using the candidate-entity set of data contained in the request. This algorithm, based on the known model, constitutes a base algorithm from which a score is derived using candidate select data in respect of the set of pre-defined data points characterising the candidate entity, the candidate select data being sourced from big data stored in the external data stores 25. Essentially, this candidate select data is subsequently weighted given its dynamic nature because of it being derived from big data.

The model match is initially done by way of the ‘Analytical Model’ ID that is presented through the API 63 at the outset, as previously described. The Analytical Model ID is generated by the customer 19 and is supplied as part of the data input during the decision request to categorise the candidate entity. The algorithms of the models stored in the analytical model library 65 take the form of a collection of expected variables and coefficients stored in a data table dictionary.

Once the ‘best matched’ model has been identified and selected from the analytical model library 65, the data structure in respect of the pre-defined data points that was parsed in the request 61 is iteratively verified against the expected bounds for each presented variable. This is performed by a function included in the validation process. If there are any errors or inconsistencies, they are recorded in the quality database of the quality data object 69 for future information.

Once the entire data request has been parsed and validated, the response is stored in the response data structure 67 along with any other information regarding the time to service and other errors.

The purpose of this encapsulated validation process is to:
(a) ensure that the candidate-entity dataset 62 that is sent to the API 63 can be used in a previous selected model;
(b) that the model appears in the analytical model library 65;
(c) that the presented data elements of the dataset 62 meet the requirements for the selected model; and
(d) that the overall validation request is performed in a suitable time period.

Retrospect Module

Once the validation module 35 functions are performed and the databases of validated candidate-entity data and matched model/algorithms are established, then the retrospect module 37 functionality is invoked. The retrospect module 37 functionality is essentially embodied within a retrospect server/database 70 and is achieved by the decision engine 13 firstly invoking a history set of functions stored in the model history data element 71 which include:
(i) a predictive software script that performs a retrospective test of the matched model selected for the candidate-entity against the validated candidate-entity dataset and stores the result in a results database comprising predicted probability results for the candidate-entity; and
(ii) an actual software script that captures actual performance data in respect of actual candidate-entity performance and stores the results in the results database as actual performance results.

The decision engine 13 then invokes a response set of functions stored in a response issues object 73 that include:
(i) the results database, which includes both predicted probability results and actual performance results, and also calibration results for the candidate-entity;
(ii) a calibration software script that performs calibration of the predicted probability results against actual performance results having regard to the selected model;
(iii) a comparison software script that performs comparison of actual performance data reflective of the actual performance results of the candidate entity and the actual performance of similar entity or entities requests received using the same model selected from the model library; and
(iv) an error margin software script that gauges the margin for error and creates a dictionary of refitted coefficients and stores the result in a database of model/algorithm refinement results.

Finally, the decision engine 13 invokes a quality function stored in the quality data element 75 that comprises a similar quality database to the validation module that records errors or inconsistencies.

In operation terms, after the candidate-entity dataset 62 has been validated and matched to a model from the analytical model library 65, the retrospect process uses the retrospect module 37 to deliver a process that backtracks past decisions and outcomes made on the candidate-entity dataset 62 compared to the expected decisions made by any selected model/algorithm.

Thus in summary, the retrospect module 37 is a collection of software functions that interact with data objects in order to validate model performance based on expected outcomes. It achieves this by taking the validated candidate-entity dataset obtained from the validation module 35 and combining it with the coefficients of the matched model from the analytical model library 65 in the previous step. This calculation is summed in order to generate the entire score in accordance with equation E1, below.

$$ln ( \frac{\hat{p}}{( 1 - \hat{p} )} ) = {b}_{0} + {b}_{1} {X}_{1} + {b}_{2} {X}_{2} + … + {b}_{p} {X}_{p} \qquad E 1$$

The score is then verified through calibrating against an established calibration measure of the selected model specified in the analytical model library 65 for the candidate-entity. This derives the predicted probability of each candidate-entity behaviour instance.

Once the expected probabilities have been properly computed they are compared to the actual performance of that instance. A second comparison is performed to also compare to the actual performance of similar entity requests received using the same model from the analytical model library 65. The comparison looks specifically at the level of fluctuation between expected and actual probabilities using a function that gauges the margin of error depending on the number of entity observations. The results of this process are then stored in the model history database of the model history data element 71 along with response timing issues stored in the response-timing database of the response issues object 73 and any quality issues stored in the quality database of the quality data element 75.

Refinement Module

Once the retrospect module 37 functions are performed and the databases of candidate-entity predicted probability results, actual performance results and calibration results are established, then the refinement module 39 functionality is invoked. The refinement module 39 functionality is essentially embodied on a refinement server/database 76 and is achieved by the decision engine 13 invoking a response set of functions 77 which include:
(i) a database of model/algorithm refinement results;
(ii) a score alignment software script that aligns the score of the actual data to fit a linear regression model of the expected probabilities for a segment of customers 21;
(iii) an in-model recalculation software script that iteratively recalculates the weighting of each of the existing model/algorithm variables and re-running a logistic regression function across them to create a revised model for the group, whereby the outcome of this process is stored in a database of refined models; and
(iv) an external-model recalculation software script that applies a combination of external variables from the matched database in combination with the current in-model to recalculate a better fitting model, whereby the outcome of this process is stored in the refined model database.

In operation terms, after the candidate-entity dataset 62 has been processed through the retrospect module 37 and compared against actual performance and performance of similar entities, the refinement module 39 looks to identify if an improved model/algorithm that has a lower rate of error compared to the previously selected matched-model is available. The new algorithm will then be stored as the new candidate entity model for the segment or entity class and joins the portfolio of previously refined algorithms in the analytical model library 65.

The refinement module 39 is a collection of software functions that interact with data objects in order to create improved models. The selected matched-model initially identified in the validation module may not have optimal performance, as measured in the retrospect module 37 through the alignment of the predicted performance and actual performance.

The refinement module 39 adopts three distinct approaches to identify if the model can be improved: (i) the Score Alignment Approach, (ii) the In-model Recalculation, and (iii) the External-model Recalculation.

In the Score Alignment Approach the probability is investigated across the scored entities within the matched segment, where data is available on multiple entities, otherwise the probability is selected based on the single entity, and in either case, it is fitted to a linear regression model in order to align with the expected probabilities. This is used to correct the score to perform an ‘as expected’ post-calculation. The outcomes of this process are stored in the refinement module data stores in the server/database 76.

In the case of the In-model Recalculation, the same variables as in the matched-model identified in the validation module are investigated. The weighting of each is iteratively recalculated and a logistic regression function is re-run across the variables to create a revised model for the matched segment (where data available on multiple entities, otherwise on the single entity).

In the case of the External-model Recalculation, this essentially follows the same process as the In-model Recalculation, except that it includes an additional step of introducing external variables and other matched data sources that are not included in the matched-model. The resultant variables and their combinations are iteratively introduced and computed, the weighting of each is recalculated and a logistic regression function re-run across them to create a revised model for the matched segment (where data available on multiple entities, otherwise on the single entity).

Comparison Module

Once the refinement module 39 functions are performed and the database of refined models/algorithms is established, then the comparison module 41 functionality is invoked. The comparison module 41 functionality is essentially embodied within a comparison server/database 78 and is achieved by the decision engine 13 invoking a further response function 79, which includes comparison software that performs a comparison between the database of refined models/algorithms score results and the database of established model score results for that category of candidate-entity objective.

By virtue of this software, a comparison value is calculated using predefined criteria that provides the highest performing score for that model/algorithm type. The best model is stored in the analytical model library 65 and identified as the “best model” for that category. The residual models are stored in the analytical model library database as established models for future comparison. The performance results of each model are also stored in the analytical model library.

In operation terms, after the refinement module 39 has identified the new candidate algorithm for the segment or individual class, the comparison module 41 is then invoked to allow a continual comparison between different algorithms stored in the analytical model library 65 with the aim to construct holistic averages of functions across scored entities and also to track the improvements of decisions being made.

The comparison module 41 is essentially a collection of software functions that compare the computed scores of nominated models, and then stores the performance results in the analytical model library 65. It operates whenever new datasets are available, which in the case of time sensitive dynamic data is virtually continuously. This could be intra-day, daily, weekly, monthly, etc whenever a dataset of an entity is updated and/or when new data fields are entered.

There are a number of factors that are reviewed between the candidate-entity models that allow a function to be run to determine a ranking system based on the perceived additional value of the performance of each of the models. This leads to a comparison value to be produced that can be used to identify the highest performing score for that particular model type. From this a measure can be achieved of the differences in the predictive power of each model type.

Thus in summary, the candidate select data in respect of the pre-defined data points that are used in the current selected algorithm/model for a candidate entity is accessed and retrieved from the database sources 25a to 25n. Any updates or changes involve the validation module process 35 checking that the data matches the expected format against schema and set boundaries. Once completed, the retrospect module process 37 backtracks past data, runs the current selected algorithm/model and looks at actual customer performance against the algorithm predicted performance. Then the refinement module process 39 looks at improving the selected algorithm to a function that has a low rate of error compared to previous decision functions. This new algorithm is then used as the new current selected algorithm for the candidate entity. The comparison module process 41 then performs a continual comparison between different algorithms with the aim to construct holistic averages of functions across scored entities and also to track the improvements of decisions being made.

Thus mathematically, as shown in equation E2 below, the availability of time sensitive dynamic data involving historic and ongoing updating of candidate-entity data, allows the base algorithm to be continually tested and improved, comparing predicted and actual outcomes.

$$\begin{matrix}ln ( \frac{\hat{p}}{( 1 - \hat{p} )} ) = {b}_{0} + {b}_{1} {X}_{1} + {b}_{2} {X}_{2} + … + {b}_{p} {X}_{p } & E 2 \\ & \\ ln ( \frac{\hat{p}}{( 1 - \hat{p} )} ) - {b}_{0} \vert {b}_{1} {X}_{1} \vert {b}_{2} {X}_{2} \vert … \vert {b}_{p} {X}_{p} & \\ ln ( \frac{\hat{p}}{( 1 - \hat{p} )} ) - {b}_{0} \vert b \text{?} {X}_{1} \vert b \text{?} {X}_{2} \vert … \vert {b}_{p} {X}_{p} & \\ \text{?} \text{indicates text missing or illegible when filed} & \end{matrix}$$

This allows for a singular decision-making algorithm to be generated per individual entity that continuously evolves/improves over time from an underlying base-algorithm.

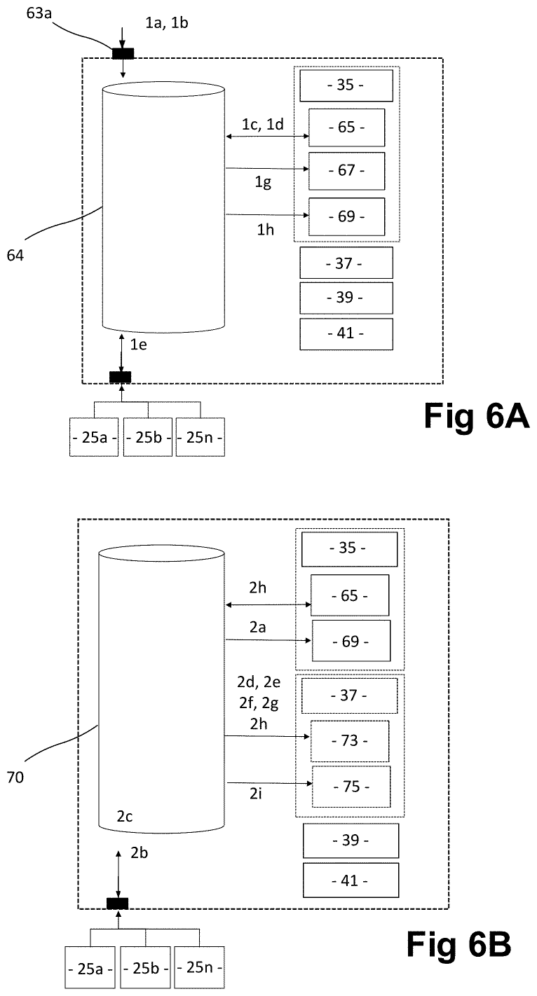

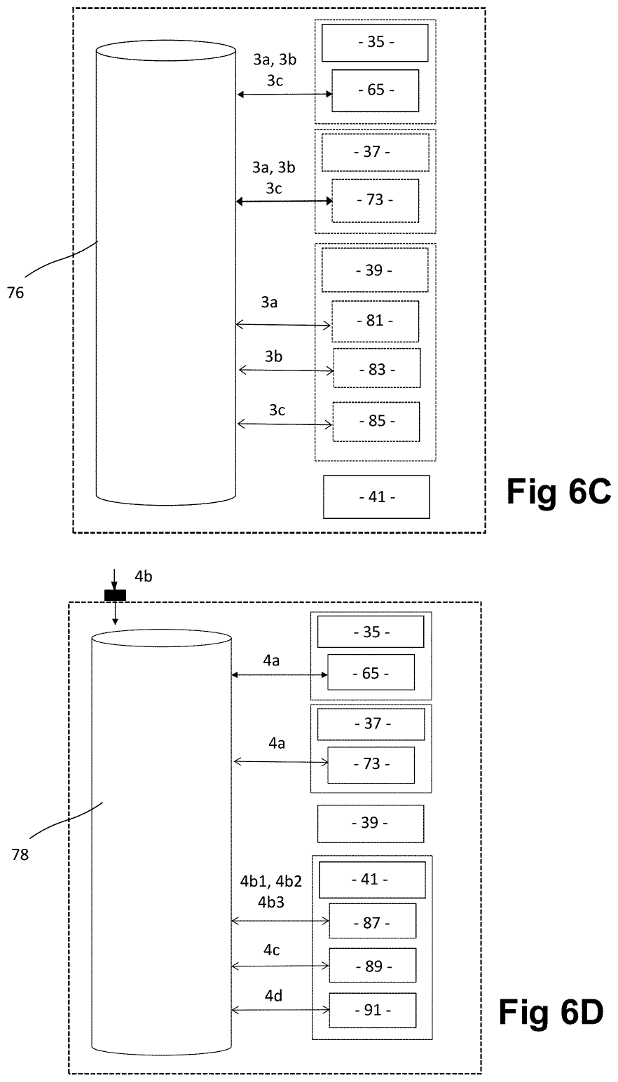

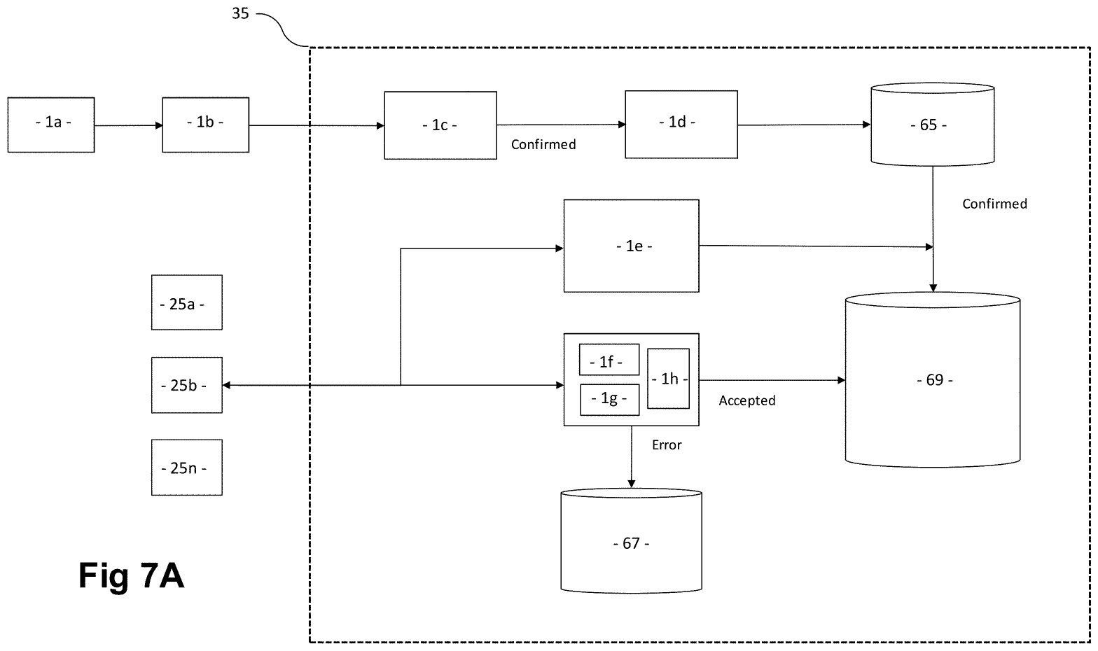

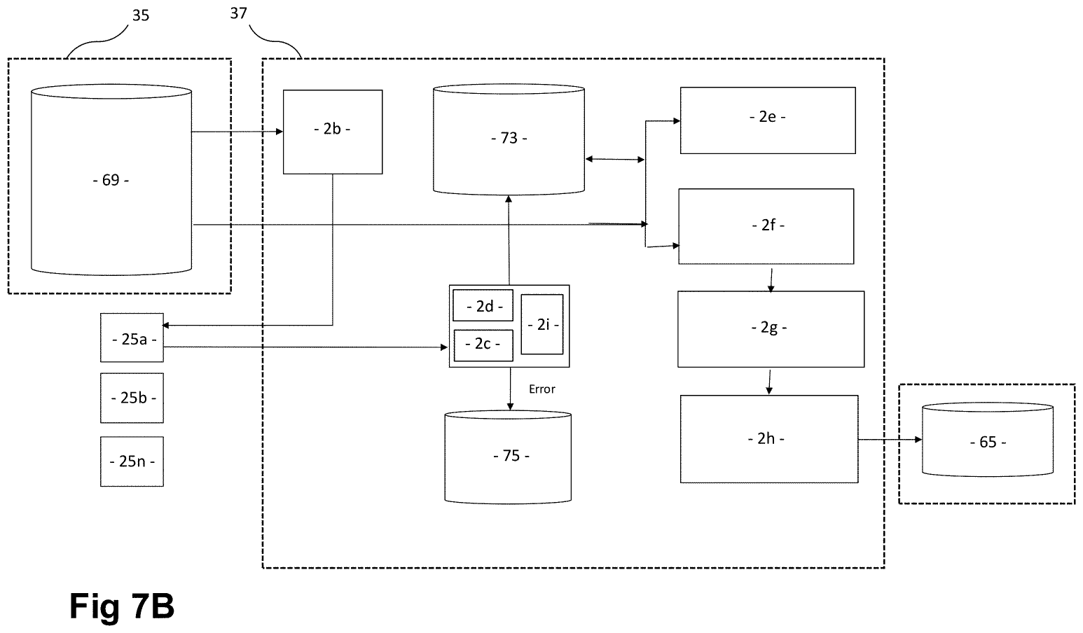

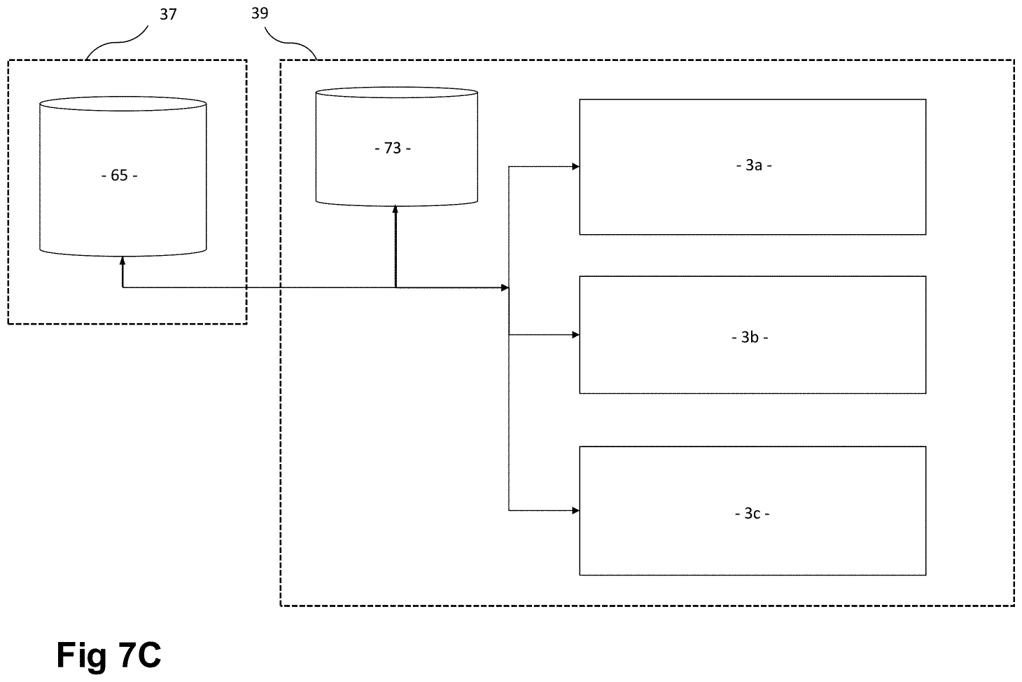

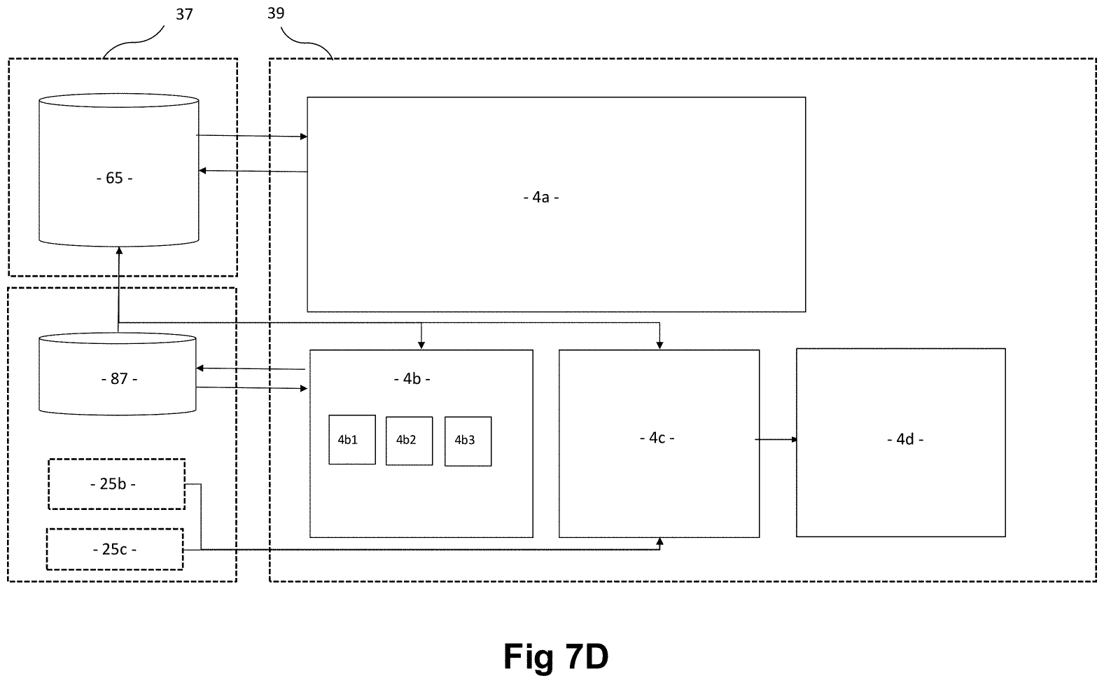

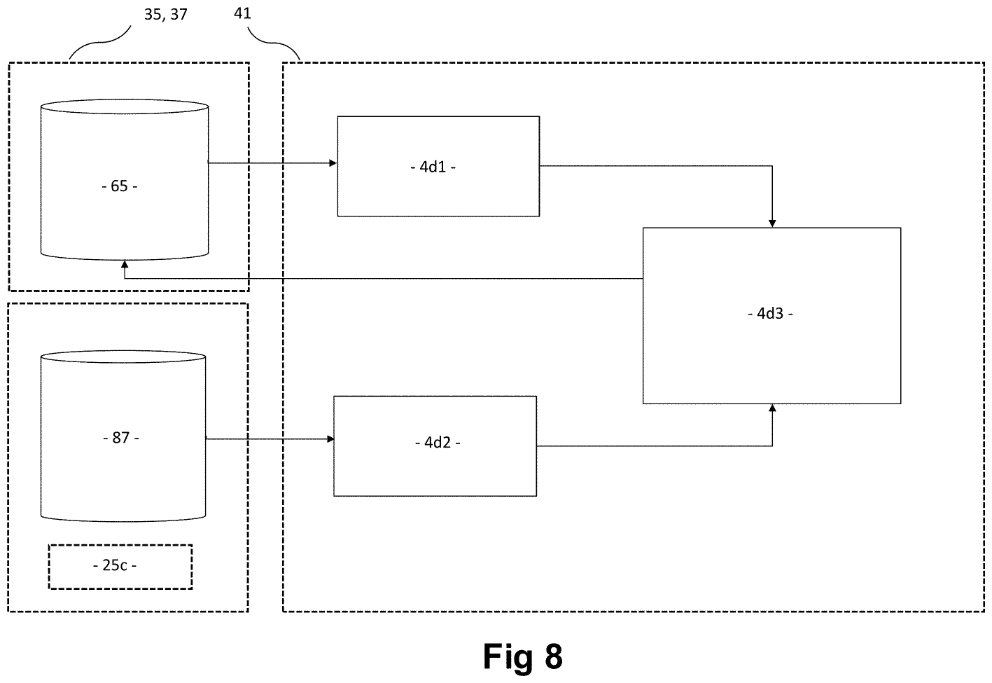

In order to better understand the operation of the various modules, the specific sequence of functions performed by each of the modules 35 to 41 will be described with respect to typical examples of a financial services organisation such as a bank making an assessment as to the credit-worthiness or financial viability of a customer and arriving at an approval decision on a credit application, as shown in FIGS. 6A to 6D and FIGS. 7A to 7D.

Dealing firstly with the validation module process 35 as shown in FIGS. 6A and 7A, a client decision request is made to the validation server/database 64 by way of an API connection 63a at step 1a, for example where the bank requests an “approval decision” on a consumer credit card application. Data in the form of Client Authorisation ID, Analytical Model ID and Candidate Identifier(s) are also received by way of the API connection 63a at step 1b, where for example the bank sends their:
‘Client Authorisation ID’ to confirm access to the data processing system 10,
‘Analytical Model ID’ for signifying that the request relates to a consumer credit card application decision request, which is then used to identify which algorithm/model stored in the analytical model library 65 to use as the base algorithm, and
‘Candidate Identifier’ to be used by the system to look up the appropriate source database 25 containing select data for the candidate entity. For example, the Candidate Identifier may comprise the bank account number, which is used to look up the candidate's account information and transactional data associated with such.

In the case of the ‘Client Authorisation ID’, the validation module process 35 conducts a client authorisation check at step 1c, where for example the system runs authorisation checking program code and confirms the bank's authorisation credentials.

In the case of the ‘Analytical Model ID’, the validation process 35 in step 1d runs model species look up program code to identify relevant models and corresponding algorithms to use that are stored in the analytical model library 65. There may be many thousands of algorithms incorporating different models that are produced virtually on a daily basis for consumer credit card applications, and some filtering of these may be deployed to select an upper percentile of algorithm/models that are subsequently investigated to determine the “best algorithm/model” for the defined category. For example, the Analytical Model Suite ID for ‘consumer card credit application’ is used to identify the appropriate model suite of algorithms and the ‘system nominated’ best algorithm/model” is matched from the database containing the analytical model library 65. In this case, the model predicts the likelihood a candidate will have a minimal monthly account balance of $500 for the next 12 months.

In the case of the ‘Candidate Identifier’, the validation module process 35 runs data request program code to request data from an appropriate data store being one of a number of different data geni using the ‘Candidate Identifier’ at step 1e. For example candidate data is sourced from the database 25b using the candidate account information and transactional data associated with such.

Data is then verified against the expected bounds for each presented variable by the validation module process 35 running data verification program code at step 1f, where for example the transactional data field for this data will have expected parameters of numeric data. Data for rectification errors or inconsistencies are recorded in the quality database 67 as quality data objects for future information by the validation module process 35 running error recording program code at step 1g. For example, if the transactional data field contains text, this data is recorded in the quality database for future investigation.

The decision request data is then stored in the response database 69, including: validated candidate data, the matched “best model” ID, time-to-service data etc. at step 1h. For example, all verified candidate bank account data is stored in the response database 69 according to a response data structure to be used in a later step for algorithm calculation.

With the retrospect module process 37 as shown in FIGS. 6B and 7B, after the validation module 35 stores the validated candidate-entity data in the response database 69, which corresponds to step 2a, a look up of a first selected genus data source database 25a for time-sensitive data related to the candidate is undertaken by running request time sensitive program code at step 2b. For example, the source database 25a is looked up for historic (time sensitive) bank account data (where dynamic data is available).

Data is then verified against the expected bounds for each presented variable by the retrospect module process 37 running data verification program code at step 2c. For example, any new bank account data is run through the validation module process 35, and the retrospect module process is continued.

Validated time sensitive data is stored in the response-timing database 73 by the retrospect module process 37 running data storage program code at step 2d. For example, the validated new bank account data is stored in the response-timing database 73. If this process has previously been completed for the candidate-entity, this data will already exist in the response-timing database 73. If dynamic data does not exist in the source database 25a, every time the look up function is run, the new select data for the data points will be recorded as the actual data in the response-timing database 73.

The actual candidate performance is measured and stored in the response-timing database 73 by the retrospect module process 37 running actual performance program code at step 2e. For example, the actual performance data of the target outcome of the algorithm for the consumer credit card application model selected, e.g. “minimum monthly account balance” is recorded in the response-timing database 73.

The retrospective test of candidate-matched best-model against candidate time-sensitive data is performed and the results stored in the response-timing database by the retrospect module process 37 running retrospective test program code at step 2f. For example the candidate time-sensitive bank account data is input into the matched “best model” to determine the probability of a “minimum monthly balance of $500” and serves as a predicted outcome.

Calibration of the candidate-entity's actual performance and candidate predicted performance from the matched best model is then performed by the retrospect module process 37 running calibration and comparison program code at step 2g. For example, the actual data of the candidate's minimum monthly balance is calibrated against the predicted outcome of the “best model” and the results are recorded.

Then the comparison of the candidate-entity's actual performance and actual performance of a similar entity's request received for the matched model-group in the analytical model library 65 is performed. For example, similar candidate(s) for consumer credit cards undergo retrospective test and calibration performance using the nominated “best model” and the results are recorded for future assessment. Whilst this request was not received for the candidate, it allows the system to understand how other similar entities of the customer are performing having regard to only their data.

The margin of error is then assessed and the dictionary of refitted coefficients is created, which are stored in the algorithm model library 65 for model refinement results by the retrospect module process 37 running coefficient refit program code at step 2h. For example, the margin of error between the predicted outcomes and the actual data is assessed, along with alternative coefficients and the data used in the refinement process.

Finally, data verification errors or inconsistencies are recorded in the quality database 75 for future information by the retrospect module process 37 running verification error program code at step 2i.

The refinement module process 39 is shown in FIGS. 6C and 7C, and commences with performing the Score Alignment Approach 81 by the refinement module process 39 running score alignment program code at step 3a. This involves the alignment of the model outcome of actual data to fit a linear regression model of the expected probabilities for the model-group matched entities of the customer. The outcome of this process is stored in the analytical model library 65 as the model refinement results. For example, the candidate's actual time sensitive bank account data is assessed to produce a simple regression model as an alternative.

The In-model Recalculation 83 is performed by the refinement module process 39 running score recalculation program code at step 3b. This involves iterative recalculation of the weighting of each of the matched “best model” variables and re-running a logistic regression function to create a revised model for the group. The outcome of this process is stored in the model suite as model refinement results. For example, the “best model's” variables are iteratively changed by the system creating a revised regression model, which is run on the candidate entity's actual time sensitive bank account data. All of the newly created models are stored in the analytical model library 65.

The External-Model Recalculation 85 is performed by the refinement module process 39 running model recalculation program code at step 3c. This applies a combination of external variables from the matched database in combination with the in-model to recalculate a better fitting model. The outcome of this process is stored in the analytical model library 65 as the model refinement results. For example, external data points outside of the bank account data, e.g. loyalty card data variables, are iteratively changed by the system creating a revised regression model which is run on the candidate entity's actual time sensitive bank account data. All of the newly created models are also stored in the analytical model library 65.

Importantly, as well as optimising the weighting of the coefficients of the variable data points, the external-model recalculation 85 looks at all of the other data variables available in the selected genus data source 25a and combines with the data variables already defined in the current ‘best model’ of the species undergoing test to see if it can produce a better-fit model.

The comparison module process 41 is shown in FIGS. 6D and 7D. This commences with the comparison module process 41 running comparison program code at step 4a that involves a comparison between:
(i) the model results produced in the refinement module 39, which are stored in the analytical model library 65;
(ii) the “best model” results of the retrospect module 37; and
(iii) other historic models also stored in the analytical model library 65 for the same species and for other species.

The model with the highest performing result is stored in the analytical model library 65 as the “best-fit model” for both that species category and the candidate-entity. Residual models and their performance data are stored in the analytical model library 65 for future reference. For example, all of the created models in the analytical model library 65—both previously created and newly created—are tested with the model best result being recorded as the best model for the “consumer credit card application” species category.

Optionally, the results can then be returned to the client of the customer by the comparison module process 41 running best mode results program code at step 4b and presenting these as the “best model” to be used for a decision. For example, the “best model” is chosen by the system to calculate the probability of the customer maintaining a minimum monthly balance of $500 in their bank account and the response is returned to the bank.

However, an important feature of the present embodiment is for the comparison module process 41 to further test the decision-making algorithm derived thus far against other external geni data sources to see if a better ‘best model’ can be created.

To achieve this, the comparison module process 41 runs retrospective models test program code at steps 4b1, 4b2 and 4b3.

At step 4b1, the retrospective models test program code performs a retrospective test of other genus-models against a representative sample of candidate time sensitive data within the same genus, using the same criteria used in the candidate assessment, including the same time-series and the same outcome of the nominated Model Suite ID.

At step 4b2, the retrospective models test program code performs calibration of the sample data actual performance and predicted performance from the genus-model is performed.

At step 4b3, the retrospective models test program code performs an assessment of the genus-model's ability to both:
(i) accurately predict the outcome of the nominated Model Suite ID; and
(ii) discriminate positive and negative results of the outcome of the nominated Model Suite ID.

The results are then stored as geni model retrospective results in a Geni Model Suite 87 and processed to generate a Calibration-Factor.

The comparison module process 41 then runs retrospective test program code at step 4c to perform a retrospective test of the Genus model against candidate time sensitive data 89. The candidate retrospective test results are then also stored in the Geni Model Suite 87.

Next, the comparison module process 41 runs best-fit comparison program code at step 4d to achieve the “best-fit model” 91 for the candidate entity. It does this in three stages.

Firstly at step 4d1, the best-fit comparison program code selects for comparison purposes, the best-fit model candidate results derived from the first genus data source 25a, which are stored in the Model Suite library 65.

Then at step 4d2, the best-fit comparison program code retrieves the model candidate results derived from the other genus, in this case genus data source 25b, from the Geni Model Suite 87, and applies the Calibration-Factor to calculate a result constituting a calibrated model derived from the second genus data source 25b.

The best-fit comparison program code then at step 4d3 compares the results of the best-fit model candidate results derived from the first genus data source 25a with the calibrated model derived from the second genus data source 25b, and ascertains the model with the highest performing result, which is then stored in the Model Suite library 65 as the current “best-fit model” for that candidate entity.

Depending upon whether other external genus data sources 25n our available or not and the configuration of the comparison module process 41, the program sequence at steps 4b, 4c and 4d can be repeated iteratively using other external genus data sources 25n to improve upon or better the current “best-fit model”.

Depending upon the number of iterations undertaken, the results can be returned to the client of the customer by the comparison module process 41 and presenting these as the “best model” to be used for a decision to be made by the client.

It should be appreciated that the scope of the present invention is not limited to the specific embodiment described as the best mode for carrying out the invention. Changes and modifications to the application software described that achieve the same outcome of the present invention are envisaged to form part of the invention and do not detract from it. For example, an alternative embodiment of the best mode may be envisaged where there is a requirement for real time customer level decisions in non-financial applications, where previous and current customer entity data can be applied to support decision analytics.

1. A computer-implemented method for generating a decision-making algorithm based on a prescribed set of pre-defined data points describing one or more characteristics of an entity to achieve an objective within a domain of data, initially modelled by an underlying base algorithm, the method including:
deriving a base algorithm to best match a candidate-entity to a known model having regard to initial data concerning the objective provided by a client;
(ii) inputting select data related to the candidate-entity from a source of data, the select data being prescribed to characterise a plurality of pre-defined data points associated with the base algorithm, the data points and base algorithm providing a qualitative measure of performance to achieve the objective;
(iii) producing an output score being a function of the base algorithm, the score being derived from applying the select data for each data point of the candidate-entity and running the base algorithm thereon;
(iv) deriving a predicted probability from the output score, the predicted probability being a weighted variable of the pre-defined data points that is used to predict the likelihood of the objective being achieved;
(v) comparing the predicted probability with an actual outcome based on actual performance data derived from the source data at a subsequent period of time relative to the applicable date of the select data;
(vi) generating a variant of the base algorithm based upon the results of the comparison;
(vii) creating a new decision-making algorithm based on the variant; and
(viii) testing the new decision-making algorithm against other data variables increasing the domain of data applicable to the candidate-entity; and
(ix) producing a better-fit model to create a revised new decision-making algorithm if justified by the other data variables.

2. A method as claimed in claim 1, wherein the other data variables are provided from the same data source as the initial domain.

3. A method as claimed in claim 1, including iteratively recalculating the weighting of each of the matched “best-model” variables and re-running a logistic regression function to create a revised model.

4. A method as claimed in claim 3, including applying a combination of external variables from the initial domain in combination with the revised model to recalculate a better fitting model to constitute the revised new decision-making algorithm.

5. A method as claimed in claim 1, wherein the other data variables are provided, or are additionally provided, from a different data source to that of the initial domain.

6. A method as claimed in claim 5, including:
(a) retrospectively testing the best-fit model constituting the revised new decision-making algorithm against a representative sample of candidate time sensitive data within the same data source and using the same data points and time period to create sample data;
(b) calibrating the sample data actual performance and predicted performance using the revised new decision-making algorithm; and
(c) assessing the revised new decision-making algorithm to both accurately predict the outcome and discriminate positive and negative results of the outcome of the revised new decision-making algorithm; and
storing the results as a calibration factor.

7. A method as claimed in claim 6, including retrospectively testing the revised new decision-making algorithm against candidate-entity time sensitive data to create candidate-entity test results.

8. A method as claimed in claim 7, including:
(a) applying the candidate-entity test results against its calibration factor to generate a calibrated candidate-entity test result,
(b) comparing the best-fit model constituting the revised new decision-making algorithm as generated from data within the previous data source with the calibrated candidate-entity test results; and
(c) selecting the model with the highest performing result as the “best-fit model” for the candidate-entity to constitute the ultimate decision-making algorithm for that candidate-entity.

9. A method as claimed in claim 1, including periodically performing the aforementioned steps using the ultimate decision-making algorithm as the derivative of the base algorithm after the prescribed period of time.

10. A method as claimed in claim 1, including during an initial phase of performing the method, where time sensitive dynamic data exists in the data source, at step (ii), inputting retrospective select data related to the candidate-entity from the source of data at a known point of time preceding the time when the actual data was generated; and using the retrospective select data as the select data for the purposes of producing the output score.

11. A method as claimed in claim 1, including where historical time sensitive dynamic data does not exist in the data source, completing an initial phase up to and including step (iv), and after a prescribed period of time, commence a subsequent phase including:
(a) inputting a new set of select data related to the candidate-entity from the source of data for each of the data points;
(b) producing a new output score derived from running the base algorithm on the select data for each data point;
(c) deriving a new predicted outcome probability from the new output score;
(d) comparing the previous predicted probability with an actual outcome based on actual data derived from the source data at a subsequent period of time relative to the select data of the preceding phase;
(e) generating a variant of the base algorithm based upon the results of the comparison;
(f) creating a new decision-making algorithm based on the variant; and
(g) periodically performing the subsequent phase using the new decision-making algorithm as the derivative of the base algorithm after the prescribed period of time.

12. A method as claimed in claim 1, including performing a validation step at the commencement of any phase where select data is input from the source data, the validation step including:
verifying and validating prospective select data for the candidate-entity to establish a validated candidate-entity dataset including time data prescribing the period of time to service the objective for decision-making purposes.

13. A method as claimed in claim 1, including performing a retrospect step after the validation step, including:
(a) calculating an output score using the base algorithm as a function of the validated candidate-entity dataset combined with the coefficients derived from the matched known model, from which a predicted probability of achieving the objective for the candidate-entity is derived;
(b) matching the predicted probability to the actual performance of the candidate-entity of the objective outcome after the prescribed period of time for servicing;
(c) comparing the level of fluctuation between the predicted probability of the objective and the actual performance using a function that gauges the margin of error depending on the number of candidate-entity observations; and
(d) storing the results of this comparison as well as any response timing issues and quality issues to enable correlations to be presented in an output report.

14. A method as claimed in claim 1, including performing a refinement step after the retrospect step, including:
(a) refitting the previously selected base algorithm used in processing of the candidate-entity data with a new decision-making algorithm derived from using modified models and algorithms therefor based on feedback of actual performance data of the candidate-entity derived from the big data;
(b) comparing the predicted performance to actual performance of the candidate-entity; and
(c) logging refined models/algorithms for the candidate-entity.

15. A method as claimed in claim 1, including performing a comparison step after the refinement step, including:
(a) comparing the score results of the refined models and algorithms with the score results of established models and algorithms for the particular model type associated with the category of the candidate-entity objective;
(b) applying a function across the score results to determine a ranking system based on the perceived additional value of each of the models and algorithms;
(c) identifying the highest performing score for the particular model type; and
(d) outputting the results providing a measure of the differences in the predictive power of each model type.

16. An analytics processing system for generating a decision-making algorithm based on a prescribed set of pre-defined data points describing one or more characteristics of an entity to achieve an objective within a domain of data initially, modelled by an underlying base algorithm, the system comprising:
a user interface to receive initial data concerning the objective from a client; and
a decision engine including a pipeline of modules programmed to:
(i) derive a base algorithm to best match a candidate-entity to a known model having regard to the initial data;
(ii) input select data related to the candidate-entity from a source of data;
(iii) produce an output score being a function of the base algorithm;
(iv) derive a predicted probability from the output score;
(v) compare the predicted probability with an actual outcome based on actual data derived from the source data at a subsequent period of time relative to the select data;
(vi) generate a variant of the base algorithm based upon the results of the comparison;
(vii) create a new decision-making algorithm based on the variant;
(viii) test the new decision-making algorithm against other data variables increasing the domain of data applicable to the candidate-entity; and
(ix) produce a better-fit model to create a revised new decision-making algorithm if justified by the other data variables;
wherein:
(a) the select data is prescribed to characterise a plurality of pre-defined data points associated with the base algorithm selected to provide a qualitative measure of performance to achieve the objective;
(b) the output score is derived from applying the select data for each data point and running the base algorithm thereon; and
(c) the predicted probability is a weighted variable of the data points that is used to predict the likelihood of the objective being achieved.

17. A system as claimed in claim 16, wherein the other data variables are provided from the same data source as the initial domain.

18. A system as claimed in claim 16, wherein the pipeline of modules is programmed to iteratively recalculate the weighting of each of the matched “best-model” variables and re-run a logistic regression function to create a revised model.

19. A system as claimed in claim 18, wherein the pipeline of modules is programmed to apply a combination of external variables from the initial domain in combination with the revised model to recalculate a better fitting model to constitute the revised new decision-making algorithm.

20. A system as claimed in any one of claim 16, wherein the other data variables are provided, or are additionally provided, from a different data source to that of the initial domain.

21. A system as claimed in claim 20, wherein the pipeline of modules is programmed to:
(a) retrospectively test the best-fit model constituting the revised new decision-making algorithm against a representative sample of candidate time sensitive data within the same data source and use the same data points and time period to create sample data;
(b) calibrate the sample data actual performance and predicted performance using the revised new decision-making algorithm; and
(c) assess the revised new decision-making algorithm to both accurately predict the outcome and discriminate positive and negative results of the outcome of the revised new decision-making algorithm; and
store the results as a calibration factor.

22. A system as claimed in claim 21, wherein the pipeline of modules is programmed to retrospectively test the revised new decision-making algorithm against candidate-entity time sensitive data to create candidate-entity test results.

23. A system as claimed in claim 22, wherein the pipeline of modules is programmed to:
(a) apply the candidate-entity test results against its calibration factor to generate a calibrated candidate-entity test result,
(b) compare the best-fit model constituting the revised new decision-making algorithm as generated from data within the previous data source with the calibrated candidate-entity test results; and
(c) select the model with the highest performing result as the “best-fit model” for the candidate-entity to constitute the ultimate decision-making algorithm for that candidate-entity.

24. A system as claimed in claim 16, wherein the pipeline of modules is programmed to periodically perform the aforementioned steps using the ultimate decision-making algorithm as the derivative of the base algorithm after the prescribed period of time.

25. A system as claimed in claim 16, wherein the pipeline of modules is programmed to, during an initial phase where historical time sensitive dynamic data exists in the data source:
input retrospective select data related to the candidate-entity from the source of data at a known point of time preceding the time when the actual data was generated; and use the retrospective select data as the select data for the purposes of producing the output score.

26. A system as claimed in claim 25, wherein the pipeline of modules is programmed to complete an initial phase up to function (iv) of claim 16, where historical time sensitive dynamic data does not exist in the data source, including functions to:
input a new set of select data related to the candidate-entity from the source of data for each of the data points;
produce a new output score derived from running the base algorithm on the select data for each data point;
derive a new predicted outcome probability from the new output score;
compare the previous predicted probability with an actual outcome based on actual data derived from the source data at a subsequent period of time relative to the select data of the preceding phase;
generate a variant of the base algorithm based upon the results of the comparison;
create a new decision-making algorithm based on the variant; and
periodically perform the subsequent phase using the new decision-making algorithm as the derivative of the base algorithm after the prescribed period of time.

27. A system as claimed in claim 16, wherein the pipeline of modules includes a validation module for invoking by the decision engine at the commencement of any phase where select data is input from the source data, the validation module including processes to verify and validate select data for the candidate-entity to establish a validated candidate-entity dataset including time data prescribing the period of time to service the objective for decision-making purposes.

28. A system as claimed in claim 27, wherein the pipeline of modules includes a retrospect module for invoking by the decision engine during a subsequent phase, the retrospect module including processes to:
calculate an output score using the base algorithm as a function of the validated candidate-entity dataset combined with the coefficients derived from the matched known model, from which a predicted probability of achieving the objective for the candidate-entity is derived;
match the predicted probability to the actual performance of the candidate-entity of the objective outcome after the prescribed period of time for servicing;
compare the level of fluctuation between the predicted probability of the objective and the actual performance using a function that gauges the margin of error depending on the number of candidate-entity observations; and
store the results of this comparison as well as any response timing issues and quality issues to enable correlations to be presented in an output report.

29. A system as claimed in claim 28, wherein the pipeline of modules includes a refinement module for invoking by the decision engine during the subsequent phase after the retrospect module, the refinement module including functions to:
refit the previously selected base algorithm used in processing of the candidate-entity data with a new decision-making algorithm derived from using modified models and algorithms therefor based on feedback of actual performance data of the candidate-entity derived from the big data;
compare the predicted performance to actual performance of the candidate-entity; and
log refined models/algorithms for the candidate-entity.

30. A system as claimed in claim 29, wherein the pipeline of modules includes a comparison module for invoking by the decision engine during the subsequent phase after the refinement module, the comparison module including functions to:
compare the score results of the refined models and algorithms with the score results of established models and algorithms for the particular model type associated with the category of the candidate-entity objective;
apply a function across the score results to determine a ranking system based on the perceived additional value of each of the models and algorithms;
identify the highest performing score for the particular model type; and
output the results providing a measure of the differences in the predictive power of each model type.
